(19) United States
(12) Patent Application Publication
(10) Pub. No.: US 2002/0048540 A1
(43) Pub. Date: Apr. 25, 2002

(54) Method to improve the selectivity of liquid-phase chemical reactions and the reactor system for this method

(75) Inventors: Masaharu Okazaki, Aichi (JP); Yoshinari Konishi, Ibaraki (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Japan as Represented by Secretary of Agency of Industrial Science and Technology, Tokyo (JP)

(21) Appl. No.: 09/748,005

(22) Filed: Dec. 27, 2000

(30) Foreign Application Priority Data
Sep. 19, 2000 (JP) 2000-283721

(51) Int. Cl. B01J 10/00; B01J 8/00

(52) U.S. Cl. 422/187; 422/190; 422/224; 422/225

(57) ABSTRACT

This invention relates to method for improving selectivity in liquid phase chemical reactions by flowing a reaction solution through a solution reaction column packed with particles having a multiplicity of nanometer-order pores, wherein the chemical reaction solution containing molecules to be reacted is flowed through mesopores having diameter on the order of several nanometers and length on the order of several ten nanometers, while simultaneously subjected to activating of the reaction thereof with reaction-initiating/accelerating means during the process; and a solution flow reaction system therefor.

### BACKGROUND OF THE INVENTION

1. Field of the Invention

The present invention relates to a method for improving selectivity in solution chemical reactions and to a reaction system therefor. More particularly, it relates to a method for improving selectivity in liquid phase chemical reactions, intended for use in the chemical industry for chemical reactions carried out using solution flow systems, for the purpose of reducing, in reactions initiated between two molecules for example, the frequency of collision with molecules other than the co-reactant molecules, or in reactions of a single type of molecule, the frequency of collision of reactant molecules in the excited state with other solute molecules, by means of controlling and lessening translation diffusion of solute and solvent molecules, thereby preventing side reactions resulting from these collisions and improving selectivity in the reaction; and to a solution flow reaction system for use with such a method.

By using effectively the method and reaction system of the invention, it is possible to afford increased yield and selectivity in targeted reactions.

2. Description of the Related Art

Methods employing micelles are known as methods for reducing collisions of reactant molecules with other solute molecules. The effect of “enclosing” reactant molecules in chemical reactions, known as the supercage effect (hereinafter abbreviated as “cage effect”) has been observed, for example, in reactions via radical pairs in micelles. However, when micelles, etc. (used herein to include inverse micelles as well) are used, solvent selection is limited, namely to water (micelles) or hydrocarbons (inverse micelles), and a procedure for separating the reaction compound from a large amount of the micelle-forming compound is required. Also where the micelle molecules are to be reused, an extra process is required for their purification. Thus, drawbacks of the conventional art include a limited number of solvent choices and a fairly laborious process for separation of the reaction product. A second prior art method for improving selectivity in reactions involves adsorption of reactant molecules into cylindrical spaces having nanometer-order diameter (nanospaces) so as to prevent translation diffusion. Where interaction with a substance providing nanospaces is strong, a procedure for separating the reaction product with a solvent or the like after reaction is typically required. Since the process is a batch process, the efficiency of the reaction and subsequent processes is low.

Currently, mesoporous silica (e.g. MCM-41) is a well known material having nanometer-order spaces whose walls consist of a chemically stable substance. In classical fluid dynamics, however, it was considered impossible for practical purposes to induce a reaction solution to flow through a 2- to 3-nanometer tube. Poiseuille's law states that volume flow is proportional to the pressure drop and the fourth power of the radius of the tube, and is inversely proportional to viscosity, so for a fine tube having a radius of 1.5 mm, a solution having viscosity of 1 centipoise will flow therethrough at a rate of 0.3 mL/min under low pressure of 0.25 pascal per 10 cm of length. If the radius were 1.5 nm, however, even if the number of tubes per unit of cross-sectional area of the column were increased proportionally to the inverse square of the radius, 250 billion pascals (2,500,000 atm) would be needed to achieve the same flow rate. Naturally, where a column is packed with a particulate material having fine pores, micron-order spaces are present between particles as well, so flow is possible at appreciably lower pressures. However, even pressure 1/100^{th} of this level is not an achievable value. Where pores are open at both ends, translation diffusion occurs, and thus it is not reasonable to assume that the cage effect will be observed in the chemical reaction. Accordingly, the idea of packing a porous material into a column and controlling a reaction by flowing a solution through the pores has not been conceived of up to now.

With the foregoing in view, as a result of assiduous research conducted with the object of developing a method for improving reaction selectivity in liquid phase chemical reactions by preventing side reactions, the inventors discovered that where a reaction solution is flowed through nanometer-order nanopores in a continuous flow process, Poiseuille's law ceases to apply so that the reaction solution can be made to flow at relatively low pressure; and that as the solution flows through the pores, the object of improved reaction selectivity can be achieved without the use of micelles, etc. by activating the reaction using reaction-initiating/accelerating means. The present invention was perfected on the basis of this discovery.

### SUMMARY OF THE INVENTION

It is an object of the present invention to provide a method for improving selectivity in liquid phase chemical reactions and a reaction system therefor. A method for improving selectivity in liquid phase chemical reactions by flowing a reaction solution through a solution reaction column packed with particles having a multiplicity of nanometer-order pores, wherein the chemical reaction solution containing molecules to be reacted is flowed through mesopores having diameter on the order of several nanometers and length on the order of several ten nanometers, while simultaneously subjected to activating of the reaction thereof with reaction-initiating/accelerating means during the process; and a solution flow reaction system therefor.

### DETAILED DESCRIPTION OF THE INVENTION

The subject which the present invention is intended to solve is to improve reaction selectivity in continuous flow processes without the use of micelles, etc. by enclosing reactant molecules within nanospaces.

It is an object of the invention to provide a method for improving selectivity in liquid phase chemical reactions.

It is a further object of the invention to provide a solution flow reaction system for use in this method.

(1) A method for improving selectivity in liquid phase chemical reactions by flowing a reaction solution through a solution reaction column packed with particles having a multiplicity of nanometer-order pores, which comprises flowing the chemical reaction solution containing molecules to be reacted through mesopores having diameter on the order of several nanometers and length on the order of several ten nanometers, while simultaneously activating the reaction thereof with reaction-initiating/accelerating means.

(2) The method for improving selectivity in liquid phase chemical reactions according to (1) above,

wherein the reaction is activated through irradiation with laser light.

(3) A solution flow reaction system for use in the method according to (1) or (2) above, comprising:

a reaction column packed with particles having a multiplicity of nanometer-order pores;

a pressure pump for flowing reaction solution;

a solution reservoir(s) for one or more reaction solutions;

a mixing chamber for mixing the reaction solutions;

a solution reservoir for accommodating reaction product after the reaction thereof;

a tube system connecting these; and

reaction-initiating/accelerating means;

wherein the reaction solution containing molecules to be reacted is fed from a solution reservoir to the mixing chamber, pumped into the reaction column under pressure by means of the pump, while simultaneously subjected to activating of the reaction thereof with the reaction-initiating/accelerating means, and then thus reacted reaction product is fed into the solution reservoir.

(4) The reaction system according to (3) above,

wherein the reaction-initiating/accelerating means laser light irradiating means.

### BRIEF DESCRIPTION OF THE DRAWINGS

FIG. 1 is a schematic illustration of the solution flow reaction system of the invention.

Description of the Symbols in the Drawings

1 Reservoirs

2 Mixing chamber

3 Pump

4 Porous material

5 Reaction column

6 Solvent reservoir

7 Laser light

### DESCRIPTION OF THE PREFERRED EMBODIMENTS

A more detailed description of the invention follows.

Acting on the hypothesis that the flow of molecules having diameters approximating the radius of nanometer-order pores through which they flow will differ appreciably from that of a macro-order continuous fluid, the inventors conducted experiments involving flowing solutions through a column (3 mm inside diameter) densely packed with micron-size particles containing 2 to 3-nanometer pores (MCM-41), and discovered that flow at flow rates about the same as those mentioned earlier can be achieved at low pressures on the order of 70 atm (7×10⁶ pascals). It was further found that during flow through nanometer-size pores, where solvent molecules that even briefly tend to form clusters are used, the molecules tend to move as a group, thus inhibiting translation diffusion in the longitudinal direction (Chemical Physic Letter, forthcoming). In a reaction of a single molecular species, for example, excited molecules do not collide with other solute molecules while flowing through the pores, thereby increasing the probability of intramolecular reactions.

Where two reacting molecules are flowed through the pores, their relative positions do not change so they do not approach other reactant molecule pairs.

It was found that the aforementioned problems can be solved by taking into consideration reaction solvent size and tendency to form clusters, and activating the reaction in a column packed with a material having pores no larger than a certain diameter, for example, mesoporous silica.

The method of the invention can be employed in reactions of single molecular species, reactions between two molecules, and reactions among a plurality of molecules. By so doing, it is possible, in reactions of a single molecular species for example, to reduce the frequency of collision of excited molecules with other solute molecules; or in intermolecular reactions, to reduce the frequency of collision of reactant molecules with molecules other than the co-reactant molecules, and to thereby inhibit side reactions resulting from such collisions.

Reactant molecules for use in the present invention include xanthone (XO) and xanthene (XH₂), described in the following Examples, but are not limited as to reactant molecule type, the invention being applicable to all manner of appropriate reactant molecules provided that reaction thereof is conducted in the liquid phase. Examples of other reactant molecules include inter alia benzophenone, diazobenzene, benzoyl peroxide, acetophenone, azobisisobutyronitrile, acetone, and dibenzoyl ketone.

Likewise the reaction solvent is not critical provided that it does not affect the packed particles (packing material).

The present invention employs particles having a multiplicity of nanometer-order pores, specifically, particles having mesopores with diameter on the order of several nanometers and length on the order of several ten nanometers. Examples of suitable particulates of this kind are micron-size mesoporous silica having 2- to 3-nanometer pores, carbon nanotubes subjected to surface modification to reduce adsorptive capacity, mesoporous aluminosilicates, and spherical-pore allophane.

The particulate is packed into a column for use. The column is a pressure resistant Pyrex column, for example; however, where the reaction-initiating/accelerating means is not light, a stainless steel column may be used, and where the reaction-initiating means is short ultraviolet, a quartz column or the like may be used. Inside diameter and length may be selected over wide ranges depending on feed pump pressure and liquid feed capability.

The flow rate of the reaction solution may be selected in such a way that the intermediate molecules participating in the target reaction will flow through the nanometer-size pores in a manner isolated from molecules that could cause side reactions, until the target reaction is completed. Selectivity can be controlled by manipulating particle pores size (type), reactant molecule and solvent type and size, reaction-initiating/accelerating means intensity, and other factors.

The solution flow reaction system employed in the invention comprises a reaction column packed with particles having a multiplicity of nanometer-order pores; a pressure pump for liquid feed; a solution reservoir(s) for one or more reaction solutions; a mixing chamber for mixing the solutions; a solution reservoir for accommodating reaction product after the reaction; a tube system connecting these; and reaction-initiating/accelerating means. These devices are not limited to any particular configuration or construction. The reaction-initiating/accelerating means may be composed, for example, of laser light irradiating means, but is not limited thereto, it being possible to employ any suitable means capable of exciting the reactant molecules and activating the reaction. Examples are infrared, x-rays, γ-rays, microwave pulses, and particle beams of various kinds.

The invention relates to a technique for flowing a reaction solution through a solution reaction column packed with a material having pore diameter of about a nanometer, in such a way that translation diffusion of the reaction solution is reduced. The effect thereof is to prevent bimolecular side reactions in many unimolecular reactions; to improve selectivity in bimolecular reactions; and to provide other advantages in reactions carried out in many organic solvents. Where micelle systems, noted for the cage effect, are used, the range of possible solvents is limited to water and the like, and after the reaction it is necessary to separate out the substance for micelle formation. With the present invention, however, provided that the packing material (silica, for example) resists disintegration, cage effects can be achieved in a wide variety of solvents, even acidic solvents or alcohols.

A fuller understanding of the invention is provided through the following example, which is merely illustrative and not limiting of the invention.

### EXAMPLE

This example examines a xanthone (XO)/xanthene (XH₂) reaction system.

(1) Evaluation of Cage Effect

When an isopropyl alcohol solution of xanthone (XO) and xanthene (XH₂) is irradiated with laser light, the xanthone, upon absorbing light, assumes an excited triplet state. If approached by xanthene, a hydrogen will be abstracted, creating a radical pair composed of the XOH•radical and the XH•radical. Random reactions among radicals result in formation of XH-XH, XOH-XH, and XOH-XOH in a 1:2:1 ratio. Where both radicals are enclosed in a small space, however, only XOH-XH forms. Therefore, where F is defined as Formula 1

$$F = \frac{[ XOH - XOH ] - [ XOH - XOH ] - [ XH - XH ]}{[ XOH - XOH ] + [ XOH - XOH ] + [ XH - XH ]} \qquad ( 1 )$$

F equals 1 when reactions occur between radical pairs only, and F equals 0 where reactions between radicals are completely random such that radical pairs are scattered at 100% probability. Thus, F is a good parameter for evaluating cage effect.

(2) Reaction Equipment

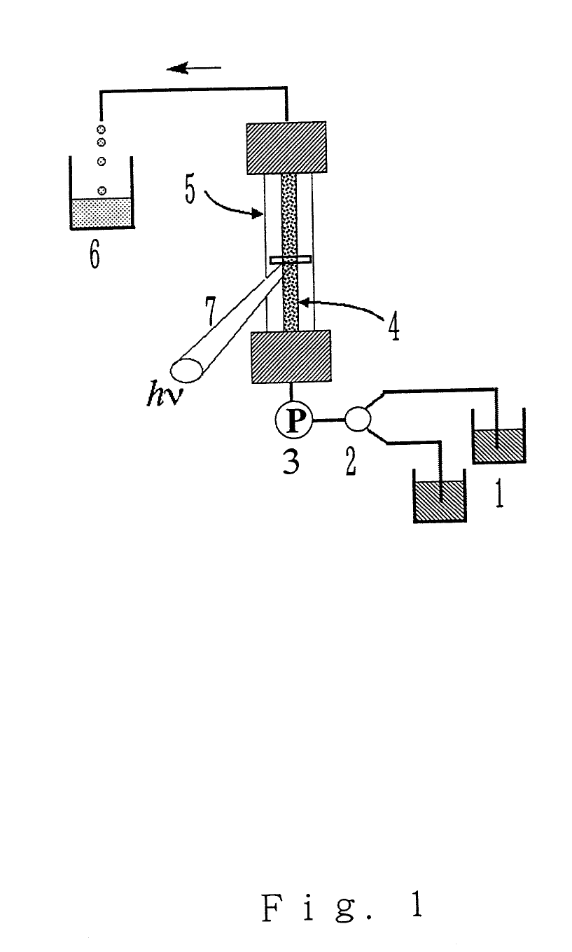

The solution flow reaction system used in the Example is depicted in FIG. 1

The reaction solution is fed from solution reservoirs 1 to mixing chamber 2 and fed into reaction column 5 under pressure from pump 3. Reaction column 5 is packed with a porous material 4 and is of pressure resistant construction. The blocks to the top and bottom of reaction column 5 are joints containing filters through which the packing material cannot pass. In this example, the reaction is brought about through irradiation with laser light 7, but the reaction could be activated suitably by other means. 6 indicates the solution reservoir and the collected reaction solution.

(3) Procedure

A 3 mm-inside diameter Pyrex column was packed with MCM-41 having pore diameter of 2.5, 3.1, or 3.9 nm (denoted respectively as MCM (2.5), MCM (3.1), and MCM (3.9)). XO (1 mM) and XH₂ (3 mM) were flowed therethrough at a flow rate of 10 cm/min and irradiated with laser light at 355 nm.

(4) Results

Analysis of the reaction product gave F values of 0.54, 0.38, and 0.15, respectively. It was found that since about half of the spaces through which liquid passed in the cell were pores, and the other half were spaces between particles, no random reactions among radical pairs occurred within pores when MCM (2.5) was used. This demonstrates that selectivity in liquid phase reactions can be controlled by manipulating pore diameter in relation to the reactant molecule(s) and solvent.

The invention set forth hereinabove relates to a method for improving selectivity in liquid phase chemical reactions by flowing a reaction solution through a solution reaction column packed with particles having a multiplicity of nanometer-order pores, wherein after initiation of the reaction the chemical reaction solution containing molecules to be reacted is flowed through mesopores having diameter on the order of several nanometers and length on the order of several ten nanometers, while activating the reaction with reaction-initiating/accelerating means during the process; and to a solution flow reaction system. The invention provides the following advantages: 1) side reactions can be prevented during liquid phase chemical reactions so as to improve selectivity in reactions, without the use of micelle systems; 2) reactions can be controlled by enclosing the reactant molecules in the nanospaces of particles having nanometer-order pores; 3) the probability of intramolecular reactions of reactant molecules can be increased; 4) translation diffusion of solute and solvent molecules can be controlled; 5) in contrast to micelle systems, there are no limitations as to solvent type, and reaction products can be isolated simply and easily; and 6) continuous flow reactions can be designed easily.

What is claimed is:

1. A method for improving selectivity in liquid phase chemical reactions by flowing a reaction solution through a solution reaction column packed with particles having a multiplicity of nanometer-order pores, which comprises flowing the chemical reaction solution containing molecules to be reacted through mesopores having diameter on the order of several nanometers and length on the order of several ten nanometers, while simultaneously activating the reaction thereof with reaction-initiating/accelerating means.

2. The method for improving selectivity in liquid phase chemical reactions according to claim 1,
wherein the reaction is activated through irradiation with laser light.

3. A solution flow reaction system for use in the method according to claim 1 or 2, comprising:
a reaction column packed with particles having a multiplicity of nanometer-order pores;
a pressure pump for flowing reaction solution;
a solution reservoir(s) for one or more reaction solutions;
a mixing chamber for mixing the reaction solutions;
a solution reservoir for accommodating reaction product after the reaction thereof;
a tube system connecting these; and
reaction-initiating/accelerating means;
wherein the reaction solution containing molecules to be reacted is fed from a solution reservoir to the mixing chamber, pumped into the reaction column under pressure by means of the pump, while simultaneously subjected to activating of the reaction thereof with the reaction-initiating/accelerating means, and then thus reacted reaction product is fed into the solution reservoir.

4. The reaction system according to claim 3,
wherein the reaction-initiating/accelerating means is laser light irradiating means.
